(19) United States
(12) Patent Application Publication
(10) Pub. No.: US 2025/0392478 A1
(43) Pub. Date: Dec. 25, 2025

(54) SYSTEM AND METHOD FOR SECURE LOCATION-PROOF & ANONYMOUS PRIVACY-PRESERVING SPECTRUM ACCESS

(71) Applicant: UNIVERSITY OF SOUTH FLORIDA, Tampa, FL (US)

(72) Inventors: Attila Altay Yavuz, Tampa, FL (US); Saleh Darzi, Tampa, FL (US)

(21) Appl. No.: 19/239,425

(22) Filed: Jun. 16, 2025

Related U.S. Application Data
(60) Provisional application No. 63/662,555, filed on Jun. 21, 2024.

(51) Int. Cl. H04L 9/32; H04L 9/08; H04W 64/00

(52) U.S. Cl. CPC H04L 9/3255; H04L 9/0872; H04L 9/321; H04W 64/00

(57) ABSTRACT

An exemplary system and method are disclosed for employing (i) a spectrum access system (SAS) configured to verify a request for spectrum usage of, or access to, a public server and respond to the request with puzzles having spectrum access information to limit the impact of malicious traffic to a network spectrum, and (ii) location-based devices and adaptive location proof mechanisms configured to verify real-time location of the origin of the request regardless of the environment the origin is located. Using proofs of location, the system employs location-based devices and mechanisms (e.g., access points, nearby devices), to validate location claims in a tamper-resistant manner. At the same time, the exemplary system can decouple user identity from access credentials, preserving anonymity and preventing tracking or profiling of users based on their spectrum usages.

### GOVERNMENT LICENSE RIGHTS

This invention was made with government support under NSF-SNSF 2444615, awarded by the National Science Foundation. The government has certain rights in the invention.

### BACKGROUND

Spectrum access system (SAS) is a cloud-based, automated frequency coordination system that governs access to shared spectrum among multiple users. The SAS dynamically assigns spectrum to various user devices (e.g., radio service devices, mobile phones, etc.) based on real-time environmental sensing, geolocation data, and regulatory constraints. The SAS can ensure interference protection for incumbents and coordinate spectrum use among the users. SAS may also interface with environmental sensing capability (ESC) networks to detect incumbent activity and trigger spectrum reallocation. There is a benefit to improving the spectrum access system.

### SUMMARY

An exemplary system and method are disclosed for employing (i) a spectrum access system (SAS) configured to verify every request for spectrum usage of, or access to, a public server and respond to the request with puzzles (e.g., time-based puzzles) having spectrum access information to limit the impact of malicious traffic to a network spectrum (e.g., provided by the Federal Communication Commission (FCC)), and (ii) location-based devices and adaptive location proof mechanisms configured to verify real-time location (e.g., providing proof of location) of the origin of the request regardless of the environment (e.g., suburban area, rural area) the origin is located at.

Current SAS relies on a static, centralized authentication infrastructure that either fails to provide verifiable proof of a user's physical location or compromises user privacy by exposing identifying information during the access process, creating security vulnerabilities such as location spoofing, unauthorized spectrum usage, and privacy breaches. In contrast, the exemplary system and method utilize puzzles embedded with spectrum access information to throttle malicious traffic at the network spectrum, thereby reducing the burden on centralized infrastructure and enhancing system robustness. Furthermore, the integration of cryptographic components (e.g., signatures, anonymous credentials, distance-bounding protocols, puzzles, etc.) can enable users to prove their location without revealing it and to access spectrum resources anonymously.

The exemplary system can employ proofs of location, generated by location-based devices and mechanisms (e.g., access points, nearby devices), to validate location claims in a tamper-resistant manner, ensuring that only users physically present in authorized regions can access the spectrum. At the same time, the exemplary system can decouple user identity from access credentials, preserving anonymity and preventing tracking or profiling of users based on their spectrum usage.

The exemplary system is well-suited for real-time applications and deployment in resource-constrained environments (e.g., mobile devices, radio networks), where secure, private, and verifiable access control is crucial. By addressing the challenges of location verifiability and user privacy, the exemplary system can represent an improvement over current technologies and provide a foundation for secure and trustworthy spectrum access in future wireless systems.

In an aspect, a system (e.g., privacy-preserving spectrum access system (privacy-preserving SAS)) having at least one private spectrum database (PSD) is disclosed comprising: a processor; and a memory having instructions stored thereon, wherein execution of the instructions causes the processor to: receive, from a user device, a privacy-preserving request for spectrum usage of or access to a public server, wherein the privacy-preserving request includes at least proof of location group signature of the user device, wherein the proof of location group signature was provided by an access point after validating location coordinates of the user device being in proximity to the access point, and wherein the privacy-preserving request includes location coordinates, time stamp (TS) of the privacy-preserving request, and one or more anonymous credentials (e.g., nym_{c}, cred_{c}), each of the user device; determine, via a signature validation operation, the validity of the proof of location group signature (e.g., using a public key (e.g., from a root issuer) and each (e.g., pseudonym nymₚ) of the one or more anonymous credentials of the user device); generate a time-based puzzle (e.g., based on predefined criteria for puzzle generation, e.g., security level, difficulty level) using a public key (e.g., from a root issuer) and the timestamp of the privacy-preserving request; and transmit the generated time-based puzzle to the user device, wherein the transmitted time-based puzzle is used by the user device in a computation task to determine a solution (e.g., token), and wherein the solution and the one or more credentials of the user device are transmitted to the public server in a request by the user device for spectrum usage of, or access to, the public server.

In some embodiments, the privacy-preserving request includes a set of delegated credentials of the user device, wherein the set of delegated credentials, formed in part by the location coordinates of the user device and the timestamp of the privacy-preserving request, were provided to the user device by a nearby device, the execution of the instructions causes the processor to: prior to the generation of the time-based puzzle, determine, via a delegated credentials validation operation (e.g., distance bounding protocol), validity of the set of delegated credentials using the public key (e.g., from a root issuer) and each of the set of delegated credentials.

In some embodiments, the puzzle is generated, via a puzzle generation operation, based on at least one predefined criteria, including security level and difficulty level.

In some embodiments, the privacy-preserving request is in form of a secured message.

In some embodiments, the public server is a cognitive radio network (CRN) server.

In some embodiments, the time-based puzzle is a time lock puzzle.

In some embodiments, the validity of the proof of location group signature is determined using a public key (e.g., from a root issuer) and each (e.g., pseudonym nymₚ) of the one or more anonymous credentials of the user device.

In another aspect, an access point (AP) is disclosed comprising: a processor; and a memory having instructions stored thereon, wherein execution of the instructions causes the processor to: receive, from a user device, a privacy-preserving request having location coordinates maintained at the user device, a timestamp for the request, and one or more anonymous credentials (e.g., nym_{c}, cred_{c}) of the user device; determine, via a proximity validation operation, validity of the location coordinates of the user device (e.g., based on signal strengths); and generate and associate a group signature with at least one of the location coordinates, the timestamp, and the anonymous credentials of the user device; and transmit the generated group signature to the user device in reply to the privacy-preserving request, wherein the user device uses the generated group signature as proof of location when sending a privacy-preserving PSD request for spectrum usage of, or access to, a public server from a user device.

In some embodiments, the proximity validation operation comprises: determining a received signal strength (RSS) of the transmission of the privacy-preserving request; measuring a round-trip time (RTT) for the transmission of the privacy-preserving request; and estimating a physical distance of the user device to the AP using the determined RSS and the measured RTT, wherein the location coordinates are valid when the location coordinates are within the estimated physical distance.

In yet another aspect, a non-transitory computer-readable medium having instructions stored thereon for a user device is disclosed, wherein execution of the instructions by a processor of the user device causes the processor to: in response to having a connection with an access point (AP) (e.g., the user device being located proximal to the AP): retrieve location coordinates of the user device from memory; retrieve one or more anonymous credentials from the memory; transmit, to the AP, a privacy-preserving request having the location coordinates, a timestamp (TS) of the request, and the retrieved one or more anonymous credentials, each for the user device; and receive, from the AP, a group signature associated with each of the location coordinates, the timestamp (TS), and the one or more anonymous credentials as proof of location, wherein the AP determines, via a proximity validation operation, validity of the location coordinates prior to the user device receiving the group signature; and transmit, to a spectrum access system (SAS) having at least one private spectrum database (PSD), a second privacy-preserving request for spectrum usage of, or access to, a public server, wherein the second privacy-preserving request includes (i) the one or more anonymous credentials and (ii) the proof of location of the user device;

In some embodiments, execution of the instructions by the processor of the user device further causes the processor to: in response to having no connection to the AP (e.g., the user device being located distal to the AP): broadcast a third privacy-preserving request to one or more nearby devices, the third privacy-preserving request having the location coordinates, a time stamp (TS) of the third request, and the one or more anonymous credentials, each of the user device, wherein the one or more nearby device is configured to determine validity of the one or more anonymous credentials using a public key (e.g., provided by the Federal Communications Commission (FCC)); and receive a set of delegated credentials from the nearby device as proof of location, wherein the set of delegated credentials is formed, in part, by the location coordinates of the user device and the timestamp of the third request; transmit, to the SAS, a fourth privacy-preserving request for spectrum usage of, or access to, a public server, wherein the fourth privacy-preserving request includes (i) the set of delegated credentials and (ii) the proof of location of the user device.

In some embodiments, execution of the instructions by the processor of the user device further causes the processor to: receive a time-based puzzle from the SAS, wherein the time-based puzzle is generated by the SAS using a public key and the timestamp of the request; determine, via a repeated squaring operation, a solution (e.g., token) to the received time-based puzzle; and transmit the determined solution and the one or more anonymous credentials to the public server, wherein the public server (i) determines, via a credential verification operation, validity of the one or more anonymous credentials and (ii) determines, via a puzzle solution verification operation, validity of the determined solution.

In some embodiments, execution of the instructions by the processor of the user device further causes the processor to: receive a time-based puzzle from the SAS, wherein the time-based puzzle is generated by the SAS using a public key and the timestamp of the third request; determine, via a repeated squaring operation, a solution (e.g., token) to the received time-based puzzle; and transmit the determined solution and the set of delegated credentials to the public server, wherein the public server (i) determines, via a credential verification operation, validity of the set of delegated credentials and (ii) determines, via the puzzle solution verification operation, validity of the determined solution.

In some embodiments, in response to the one or more anonymous credentials and the solution being determined valid, the public server grants access to the user device.

In some embodiments, in response to the one or more anonymous credentials and the solution being determined valid, the SAS updates the PSD.

In some embodiments, the proximity validation operation comprises: determining a received signal strength (RSS) of the transmission of the privacy-preserving request; measuring a round-trip time (RTT) for the transmission of the privacy-preserving request; and estimating a physical distance of the user device to the AP using the determined RSS and the measured RTT, wherein the location coordinates are valid when the location coordinates are within the estimated physical distance.

In some embodiments, the proximity validation operation (e.g., DBP protocol) is configured to: estimate a physical distance between the user device and the AP using the location coordinates of the user device and location coordinates of the AP; and in response to the estimated physical distance being smaller than or equal to a distance threshold value, output an indication that the location coordinates of the user device is valid.

In some embodiments, the received group signature is generated, via a group signature generation operation, using a security parameter and a secret key (sk) of the user device.

In some embodiments, the privacy-preserving request is configured as a secured message.

In some embodiments, the public server is a cognitive radio network (CRN) server.

### BRIEF DESCRIPTION OF DRAWINGS

FIGS. 1A-1B each shows an example privacy-preserving and counter-Denial-of-Service (counter-DoS) system for protecting private information of an internet user when the user tries to access, via his/her user device, a public server by employing a spectrum access system (SAS) configured to provide, via a public network, the user device with time-based puzzle to solve for a puzzle solution that the public server can verify to grant access to the user device, in accordance with an illustrative embodiment. In FIG. 1A, the user device is configured to (i) validate its location using a nearby access point (AP) and (ii) communicate, through the AP via the public network, with the SAS and the public server. In FIG. 1B, the user device is configured to (i) validate its location using one of a plurality of nearby devices and (ii) communicate, via only the public network, with the SAS and the public server.

FIGS. 2A-2B each shows an example operation flow for the exemplary system and method. FIG. 2A shows the communication between the spectrum access system (SAS), the user device, the access point (AP), and the public server. FIG. 2B shows the communication between the spectrum access system (SAS), the user device, the nearby devices, and the public server.

FIG. 3A shows an exemplary system comprising a Federal Communications Commission (FCC), private spectrum databases (PSDs), a user device (shown as client), a cognitive radio network (CRN) server, and an access point (AP). FIGS. 3B-3D show example algorithmic implementations for the components/entities of the system in FIG. 3A.

### DETAILED DESCRIPTION

Some references, which may include various patents, patent applications, and publications, are cited in a reference list and discussed in the disclosure provided herein. The citation and/or discussion of such references is provided merely to clarify the description of the disclosed technology and is not an admission that any such reference is “prior art” to any aspects of the disclosed technology described herein. In terms of notation, “[n]” corresponds to the nth reference in the list. For example, [1] refers to the first reference in the list. All references cited and discussed in this specification are incorporated herein by reference in their entirety and to the same extent as if each reference were individually incorporated by reference.

### Example System

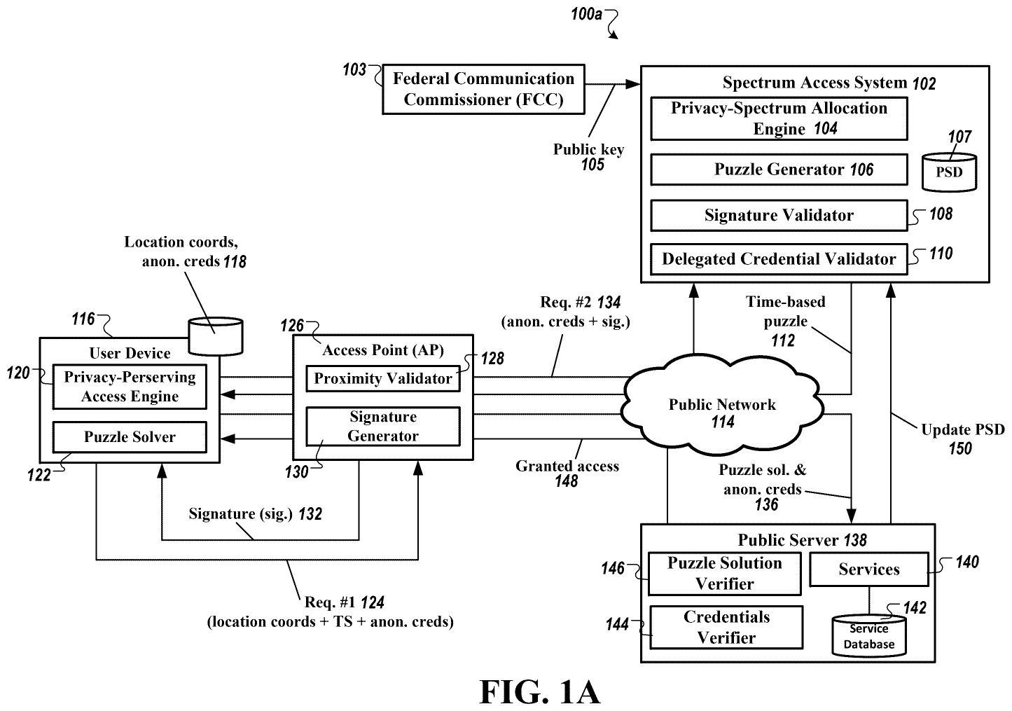

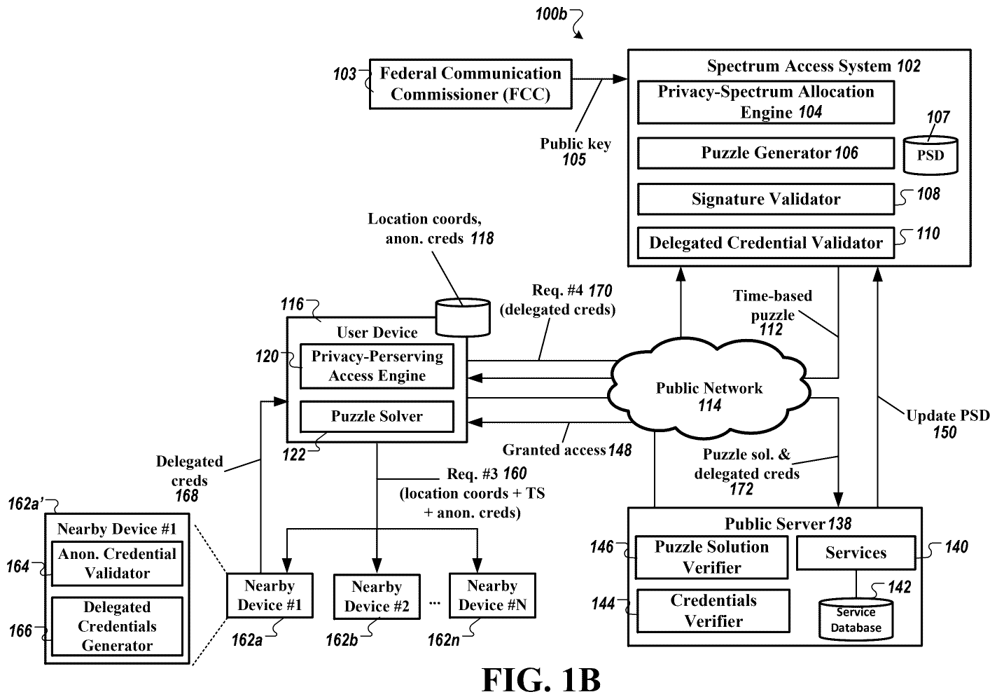

FIGS. 1A-1B each shows an example privacy-preserving and counter-Denial-of-Service (counter-DoS) system 100 (shown as 100a, 100b) for protecting private information (e.g., metadata) of an internet user when the user tries to access, via a user device 116, a public server 138 by employing a spectrum access system 102 (SAS) configured to provide, via a public network 114, the user device 116 with time-based puzzle 112 (e.g., hash-based or lattice-based time-lock puzzle) to solve for a puzzle solution (e.g., security token) that the public server 138 can verify to grant access to the user device 116, in accordance with an illustrative embodiment. In FIG. 1A, the user device 116 is configured to (i) validate its location using a nearby access point (AP) 126 (e.g., Wi-Fi modem) and (ii) communicate, through the AP 126 via the public network 114, with the SAS 102 and the public server 138. In FIG. 1B, the user device 116 is configured to (i) validate its location using one of a plurality of nearby devices 162 (shown as 162a-162n) and (ii) communicate, via only the public network 114, with the SAS 102 and the public server 138.

Privacy-preserving requests (e.g., 124, 134, 160, 170), transmitted between the components (e.g., SAS 102, user device 116, AP 126, nearby device 162, and public server 138) of the system 100a-100b, can be configured as a secured message.

Privacy-Preserving Spectrum Access System (102). In the examples shown in FIGS. 1A-1B, before communicating with any devices (e.g., 116) or public servers (e.g., 138), the SAS 102 can, via its privacy-spectrum allocation engine 104, generate/set up a privacy-preserving spectrum database (PSD) 107 to allocate and provide users with spectrum availability information, in form of puzzles.

In an embodiment, the SAS 102 can generate, via its puzzle generator 106, a time-based puzzle 112 in response to receiving, from the user device 116, a privacy-preserving request (e.g., 134 or 170) for spectrum usage of, or access to, the public server 138. In another embodiment, the SAS 102 can retrieve a time-based puzzle 112 stored in the PSD 107 in response to receiving, from the user device 116, the privacy-preserving request (e.g., 134 or 170), where the time-based puzzle 112 was created, by the SAS 102, in response to receiving a previous similar, or substantially similar, privacy-preserving request. The time-based puzzle 112 can be either a hash-based or a lattice-based time-lock puzzle, configured to ensure post-quantum security.

The SAS 102 can employ (i) a signature validator 108 (e.g., distinct cryptographic path method) configured to verify a signature (e.g., group signature, ring signature), from the user device 116 when in proximity with the AP 126, included in the privacy-preserving request 134, and (ii) a delegated credential validator 110 configured to verify delegated credentials 168, from the user device 116 when in proximity with nearby devices 162 without the AP 126, included in the privacy-preserving request 170.

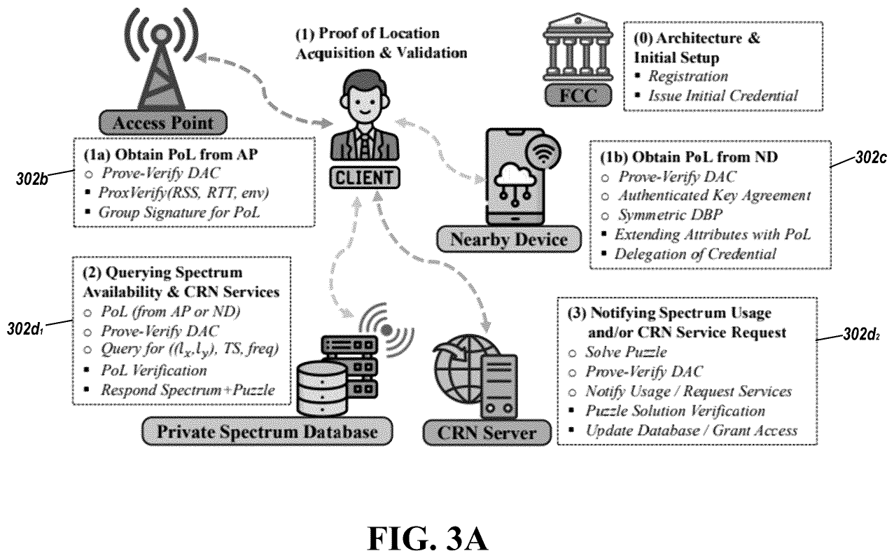

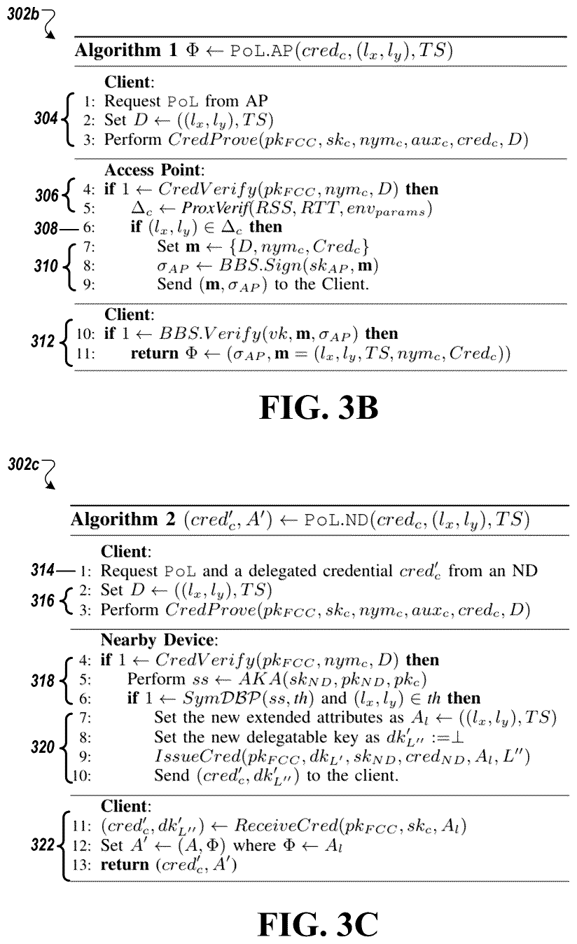

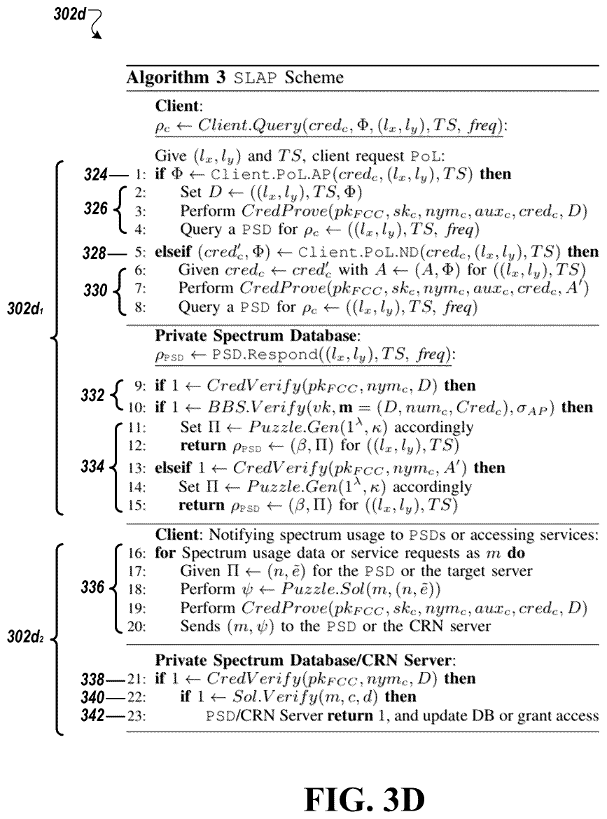

In FIG. 1A, after receiving, from the user device 116, through the AP 126 and via the public network 114, the privacy-preserving request 134 having anonymous credentials of the user device 116 and signature 132 generated by the AP 126, the SAS 102 can determine, via the signature validator 108, the validity of the signature 132 (as a proof of location for the user device 116) using a public key 105 issued by the Federal Communications Commission 103 (FCC) and each of the anonymous credentials of the user device 116 (see lines 9-11 and 13-14, FIG. 3D). The SAS 102 can then generate, via its puzzle generator 106, the time-based puzzle 112, based on predefined criteria for puzzle generation (e.g., security level, difficulty level), using the public key 105 and TS of the request 124 (see lines 11 or 14, FIG. 3D). The SAS 102 can then transmit, via the public network 114 through the AP 126, the time-based puzzle 112 to the user device 116 (see line 12 or 15, FIG. 3D), so that the user device 116 can solve the puzzle 112 for a puzzle solution and send the puzzle solution, along with credentials (e.g., anonymous, delegated), to the public server 138 (see lines 16-20, FIG. 3D) for specturm usage of, or access to, the public server 138.

In FIG. 1B, after receiving, from the user device 116 via only the public network 114, the privacy-preserving request 170 having delegated credentials 168 generated by one (e.g., 162a, shown as 162a′) of the nearby devices 162a-162n, the SAS 102 can determine, via the delegated credential validator 110, the validity of the delegated credentials 168 (as a proof of location for the user device 116) using the public key 105 (see lines 9-11 and 13-14, FIG. 3D). The SAS 102 can then (i) generate the time-based puzzle 112 using the public key 105 and TS of the request 160 (see lines 11 or 14, FIG. 3D), and (ii) transmit, via the public network 114, the time-based puzzle 112 to the user device 116 (see lines 12 or 15, FIG. 3D). The user device 116 can then solve the puzzle 112 for a puzzle solution and send the puzzle solution, along with credentials (e.g., anonymous, delegated), to the public server 138 (see lines 16-20, FIG. 3D) for spectrum usage of, or access to, the public server 138.

Privacy-Preserving DOS-Countering User Device (116). In the examples shown in FIGS. 1A-1B, the user device 116 (e.g., smartphone, tablet, smartwatch, etc.) can store its spectrum management parameters 118, including location coordinates and anonymous credentials (e.g., post-quantum anonymous credentials), in its local memory. The user device 116 can employ (i) a privacy-preserving access engine 120 configured to generate a privacy-preserving request (e.g., 124, 160) having one or more spectrum management parameters (e.g., location coordinates, timestamp (TS) of the request 124 or 160, anonymous credentials) and (ii) a puzzle solver 122 configured to solve the time-based puzzle, received from the SAS 102, for a puzzle solution.

In FIG. 1A, the user device 116 is in proximity to the AP 126. To request spectrum usage of, or access to, the public server 138, the user device 116 can first (i) generate the privacy-preserving request 124 (see lines 1-2, FIG. 3B), and (ii) transmit, via a wireless connection, the request 124 to the AP 126 (see line 3, FIG. 3B). The request 124 can include its TS, location coordinates, and anonymous credentials of the user device 116 that the AP 126 can use to (i) determine, via a proximity validator 128, the validity of the location coordinates of the user device 116 (see lines 4-5, FIG. 3B) and (ii) generate and associate, via a signature generator 130, the signature 132 (e.g., group, ring) with at least one of the TS, location coordinates, and anonymous credentials of the user device 116 (see lines 6-9, FIG. 3B).

In an embodiment, the proximity validator 128 can determine the validity of the location corodinates of the user device 116 by (i) determining the received signal strength (RSS) of the transmission of the request 124, (ii) measuring the round-trip time (RTT) for the transmission of the request 124, and (iii) estimating the physical distandce of the user device 116 to the AP 126 using the determined RSS and measured RTT. When the location coordinates of the user device 116 are within the estimated physical distance, the validator 128 may determine the location coordinates as valid. In another embodiment, the proximity validator 128 can be implemented using the distance bounding protocol (DBP) that (i) estimates the physical distance between the user device 116 and the AP 126 using the location coordinates of the user device 116 and the AP 126, and (ii) determine the user device 116 as valid when the estimated physical distance being smaller than or equal to a distance threshold value.

After receiving, from the AP 126, the signature 132 as proof of location (POL) (see lines 10-11, FIG. 3B), the user device 116 can transmit, to the SAS 102, through the AP 126 via the public network 114, the privacy-preserving request 134 having the signature 132 and the anonymous credentials of the user device 116 (see lines 1-4, FIG. 3D), so that the SAS 102 can (i) validate, via the signature validator 108, the signature 132 using the public key 105 and each of the anonymous credentials of the user device 116 (see lines 9, 10, and 13, FIG. 3D) and (ii) generate and transmit, via the public network 114 through the AP 126, the time-based puzzle 112 back to the user device 116 (see lines 11, 12, 14, and 15, FIG. 3D). The user device 116 can then (i) solve, via the puzzle solver 122 (e.g., repeated squaring operator), the time-based puzzle 112 for a puzzle solution (e.g., security token) (see lines 16-19, FIG. 3D), and (ii) transmit, through the AP 126 via the public network 114, the puzzle solution and anonymous credentials (shown as 136) to the public server 138 (see lines 20, FIG. 3D) to request spectrum usage of, or access to, the services 140 or data of interest stored in a service database 142 of the public server 138.

In FIG. 1B, the user device 116 is not close to the AP 126, but the user device 116 is in proximity to nearby devices 162a-162n (e.g., smartphones, tablets, etc.). To request spectrum usage of, or access to, the public server 138, the user device 116 can first broadcast, to the nearby devices 162a-162n via a wireless connection, a privacy-preserving request 160 having one or more spectrum management parameters, including TS of the request 160, location coordinates, and anonymous credentials of the user device 116 (see lines 1-3, FIG. 3C). Only one (e.g., 162, shown as 162a′), of the nearby devices 162a-162n receiving the request 160, may respond to the user device 116 based on the received signal strength (RSS) of the request 160 and the physical distance between the responding nearby device (e.g., 162a) and the user device 116. The responding nearby device (e.g., 162a) can (i) determine, via its anonymous credential validator 164 (e.g., distance bounding protocol), the validity of the anonymous credentials of the user device 116 (see lines 4-5, FIG. 3C), and (ii) generate, via its delegated credentials generator 166, a set of delegated credentials 168 to transmit to the user device 116 (see lines 6-10, FIG. 3C). The set of delegated credentials 168 can be formed in part by the location coordinates of the user device 116 and the TS of the request 160.

After receiving, from the responding nearby device (e.g., 162a), the set of delegated credentials 168 (see lines 11-13, FIG. 3C), the user device 116 can transmit, to the SAS 102 via only the public network 114, a privacy-preserving request 170 having the set of delegated credentials (see lines 5-8, FIG. 3D), so that the SAS 102 can (i) determine, via the delegated credential validator 110, the validity of the set of delegated credentials 168 (see lines 9, 10, and 13, FIG. 3D) and (ii) generate, via the puzzle generator 106, the time-based puzzle 112 using the public key 105 and the TS of the request 160 (see lines 11, 12, 14, and 15, FIG. 3D). After receiving, from the SAS 102, the time-based puzzle 112, the user device 116 can solve, via the puzzle solver 122 (e.g., repeated squaring operator), for a puzzle solution (e.g., security token) (see lines 16-19, FIG. 3D). The user device 116 can then transmit, via the public network 114, the puzzle solution and set of delegated credentials (shown as 172) to the public server 138 (see line 20, FIG. 3D) to request spectrum usage of, or access to, the services 140 or data of interest stored in the service database 142.

DOS-Countering Public Server (138). In the examples shown in FIGS. 1A-1B, the public server 138 can employ (i) a credentials verifier 144 configured to determine the validity of the anonymous or delegated credentials received from the user device 116, and (ii) a puzzle solution verifier 146 configured to determine the validity of the puzzle solution received from the user device 116. After the credentials (e.g., anonymous, delegated) and the puzzle solution are determined valid (see lines 21-22, FIG. 3D), the public server 138 can grant the user device 116 access 148 to the services 140 or data of interest stored in the service database 142 (see lines 23, FIG. 3D). After the access grant 148, the public server 138 can send a request 150 to update the PSD 107 of the SAS 102.

In some embodiments, the public server 138 can be a database-driven cognitive radio network (CRN) server configured to make location-based decisions and provide location-based services. The public server 138 can apply to a broad range of location-based services, requiring minimal adaptation.

### Example Operation Flow

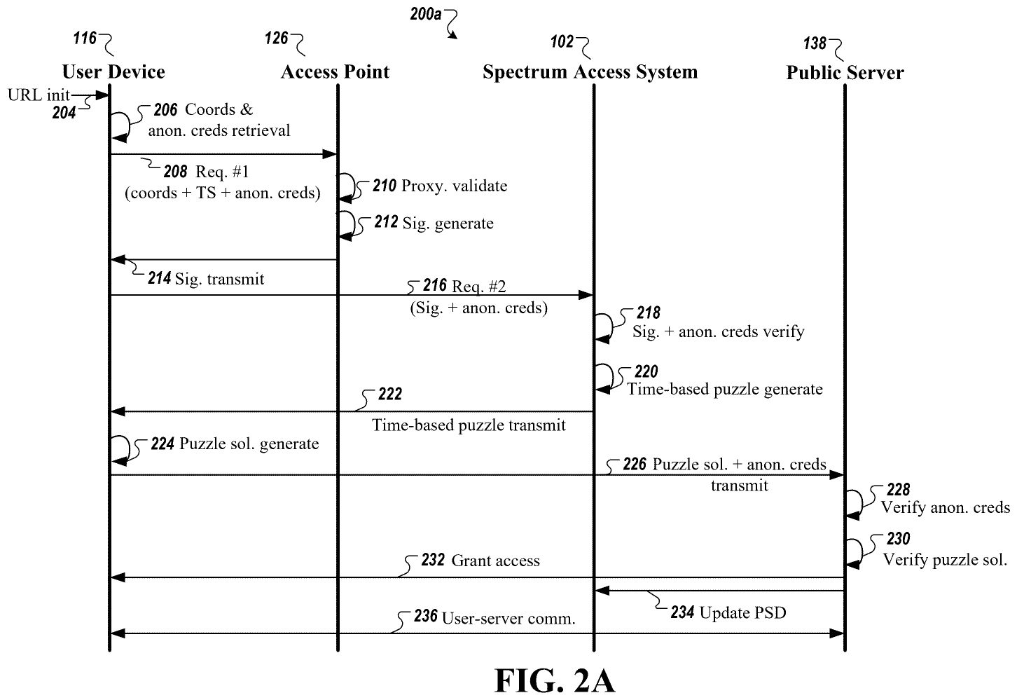

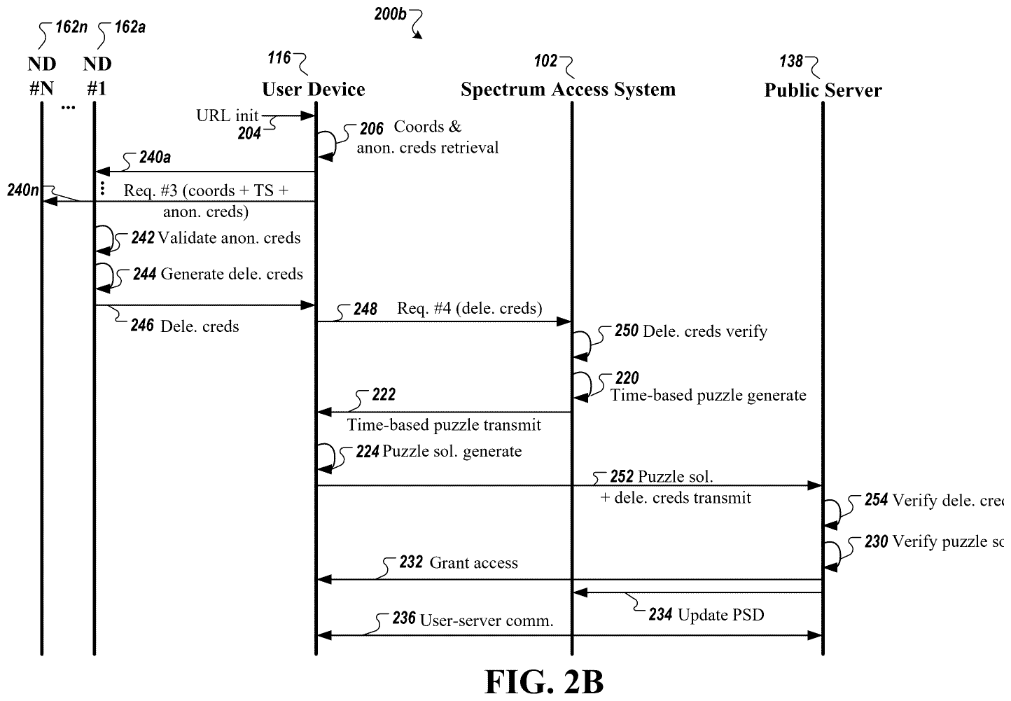

FIGS. 2A-2B each shows an example operation flow 200 (shown as 200a, 200b) for the exemplary system and method. FIG. 2A shows the communication between the spectrum access system (SAS) 102, the user device 116, the access point 126 (AP), and the public server 138. FIG. 2B shows the communication between the spectrum access system (SAS) 102, the user device 116, the nearby devices 162 (shown as 162a-162n), and the public server 138.

In the example shown in FIG. 2A, the flow 200a can start when a URL is initiated/entered (204) on a web browser of the user device 116. The user device 116, e.g., via the web browser or network utility application, can then retrieve (206) its location coordinates and anonymous credentials from local memory. The user device 116 can then transmit (208), to the AP 126 via a wireless connection, a privacy-preserving request #1 (see 124, FIG. 1A) that includes its timestamp (TS), location coordinates, and anonymous credentials of the user device 116.

After receiving the privacy request #1 from the user device 116, the AP 126 can validate (210), via its proximity validator (see 128, FIG. 1A), the location coordinates of the user device 116, and generate (212), via its signature generator (see 130, FIG. 1A), a signature (see 132, FIG. 1A) (e.g., group, ring) associated with at least one of the TS, location coordinates, and anonymous credentials of the user device 116. The AP 126 can then transmit (214), via a wireless connection, the signature back to the user device 116.

After receiving, from the AP 126, the signature, the user device 116 can transmit (216), to the SAS 102, through the AP 126 via a public network (see 114, FIGS. 1A-1B), a privacy-preserving request #2 (see 134, FIG. 1A) having the signature and the anonymous credentials of the user device 116.

After receiving, from the user device 116, the privacy request #2, the SAS 102 can verify (218), via its signature validator (see 108, FIGS. 1A-1B), the signature using a public key (see 105, FIGS. 1A-1B) and each of the anonymous credentials of the user device 116. The SAS 102 can then generate (220) a time-based puzzle (see 112, FIGS. 1A-1B), using the public key and TS of the request #1, based on predefined criteria (e.g., security level, difficulty level), and (ii) transmit (222), via the public network through the AP 126, the time-based puzzle back to the user device 116.

After receiving, from the SAS 102, the time-based puzzle, the user device 116 can generate (224), via its puzzle solver (see 122, FIGS. 1A-1B) (e.g., repeated squaring operation), a puzzle solution. The user device 116 can then transmit (226), through the AP 126 via the public network, the puzzle solution and anonymous credentials of the user device 116 to the public server 138.

After receiving, from the user device 116, the puzzle solution and anonymous credentials, the public server 138 can (i) verify (228), via its credentials verifier (see 144, FIGS. 1A-1B), the anonymous credentials of the user device 116, and (ii) verify (230), via its puzzle solution verifier (see 146, FIGS. 1A-1B), the puzzle solution generated by the user device 116. If the anonymous credentials and puzzle solution are both valid, the public server 138 can (i) grant (232) the user device 116 access to the services and data of the public server 138, and (ii) update (234) the PSD (see 107, FIGS. 1A-1B) of the SAS 102. The public server 138 and the user device 116 can then communicate (236) (e.g., send/receive resources), via the public network through the AP 126, back and forth with each other.

In the example shown in FIG. 2B, subsequent to the retrieval (206) of the location coordinates and anonymous credentials, the user device 116 can broadcast (240a-240n) a privacy-preserving request #3 (see 160, FIG. 1B) to a plurality of nearby devices 162a-162n (e.g., smartphones, tablets, etc.) in proximity to the user device 116. The privacy-preserving request #3 can include its time stamp (TS), location coordinates, and anonymous credentials of the user device 116. Based on the received signal strength (RSS) of the broadcast and the location of the nearby devices, only one (e.g., 162a) of the nearby devices 162a-162n may respond to the user device 116. Specifically, the responding nearby device (e.g., 162a) can validate (242), via its anonymous credential validator (see 164, FIG. 1B), the anonymous credentials of the user device 116, and generate (244), via its delegated credentials generator (see 166, FIG. 1B), a set of delegated credentials using the location coordinates of the user device 116 and the TS of the request #3. The responding nearby device (e.g., 162a) can then transmit (246), via a wireless connection, the set of delegated credentials to the user device 116 as proof of location. The user device 116 can then transmit (248), via a public network (see 114, FIGS. 1A-1B), the set of delegated credentials to the SAS 102.

After receiving, from the user device 116, the set of delegated credentials, the SAS 102 can validate (250), via its delegated credential validator (see 110, FIGS. 1A-1B), the set of delegated credentials using a public key (see 105, FIGS. 1A-1B) and each of the set of delegated credentials.

Subsequent to the generation (224) of the puzzle solution, the user device 116 can transmit (252), via the public network, the puzzle solution and the set of delegated credentials to the public server 138. The public server 138 can then verify (254), via its credential verifier (see 144, FIGS. 1A-1B), the set of delegated credentials, and verify (230), via its puzzle solution verifier (see 146, FIGS. 1A-1B), the puzzle solution recevied from the user device 116.

### Example Secure Location-Proof and Anonymous Privacy-Preserving Spectrum Access (SLAP) System

In some embodiments, the exemplary system (also referred to as “SLAP”) comprises five entities/components: the Federal Communications Commission (FCC), private spectrum databases (PSDs), users, servers, and access points (APs). Specifically, the FCC is a central authority governing spectrum access systems (SAS), responsible for establishing system parameters and enforcing regulatory compliance. Private Spectrum Databases (PSDs) encompass multiple geo-location spectrum databases [1], [5], providing real-time spectrum availability data. PSDs operate in adherence to FCC regulations, ensuring synchronization and consistency. Users (also referred to as clients) are a group that includes both primary users (PUs) and secondary users (SUs) equipped with various user devices (e.g., laptops, IoT, smartphones). PUs supply spectrum usage data to PSDs, while SUs query these databases for spectrum availability and CRN services. Additionally, a Nearby Device (ND) refers to any verified user within proximity. Servers are diverse network service providers (e.g., CRN, web, cloud servers) that users access for specific services. Access Points (APs) are existing WiFi access points or cellular network towers in the area, equipped with synchronized clocks.

Initial Setup of Entities/Components. Geolocation databases can store frequency information and synchronize as mandated by the FCC [1]. APs within a region can function as a group, each holding a pair of secret key sk_{AP} and the group verification key GK, generated by the FCC using (sk, GK)←BBS.KeyGen (param_{G}). To estimate a user device's physical distance, an AP can perform signal strength analysis and round-trip time (RTT) measurements. Using the received signal strength (RSS), RTT, and environmental parameters (envₚₐᵣₐₘₛ), the algorithm function Δ←ProxVerif (RSS, RTT, envₚₐᵣₐₘₛ) can compute and output the estimated physical distance of the user device. The FCC can act as a root issuer for credentials in the exemplary system. For a set of attributes A associated with a user device (e.g., device ID, type), the FCC can issue Level 1 root credentials to all registered user (PU and SU) devices using the algorithm function CreateCred (L′, A, sk_{FCC}). Each user device identified by the pseudonym nymᵤ can obtain its credential via the algorithm function GetCred (pk_{FCC}, skᵤ, A)→(credᵤ, (\vec{C},\vec{O}), dk_{L′}). The credential credᵤ can consist of a set commitment C over attributes A, rooted in the FCC's public key pk_{FCC}, the corresponding opening information \vec{O}, and a delegation key dk_{L′} enabling delegation up to level L′. With this credential, the user device can renew its pseudonym nymᵤ or delegate its credentials to another user device by switching to a new public key and optionally extending the attribute set to A′. Demonstrating possession of the credential can involve the user device proving ownership of the secret key skᵤ and generating a randomized signature over the required attributes.

FIG. 3A shows an example system (“SLAP”) comprising a Federal Communications Commission (FCC), private spectrum databases (PSDs), a user device (shown as client), a cognitive radio network (CRN) server, and an access point (AP). FIGS. 3B-3D show example algorithmic implementations (e.g., 302b-302d) for the components/entities (e.g., FCC, PSDs, user device, CRN server, and AP) of the system in FIG. 3A.

Proof of Location Acquisition and Validation (302b-302c). In this phase, the user device can obtain a valid proof of location (POL) for a specified time and geographic area, with the process tailored to two complementary scenarios: densely populated areas with robust infrastructure and rural regions with limited resources.

FIG. 3B shows an example algorithmic implementation 302b for the user device to validate its location (e.g., getting proof of location) using an access point (AP). When the AP is within the user device's proximity, the user device can request a POL from the AP with the strongest signal. At lines 1-3 (304), using anonymous credentials (nym_{c}, cred_{c}), the user device can specify attributes D, timestamp (TS), and location coordinates (lₓ, l_{y}), and verify their credentials with the FCC's public key. At lines 4-5 (306), upon successful verification, the AP can evaluate proximity using signal strength and round-trip time (RTT) measurements. If proximity is validated (line 6, (308)), the AP can generate a group signature on the user device's location, timestamp, and credentials and transmit the group signature to the user device (lines 7-9, (310)). At lines 10-11 (312), the user can then verify the group signature and accept the group signature as valid proof of location.

FIG. 3C shows an example algorithmic implementation 302c for the user device to validate its location (e.g., getting proof of location) using one of the nearby devices (NDs). When the AP is within the user device's proximity, the user device can request a POL from the AP with the strongest signal. In sparsely populated areas lacking WiFi APs or cellular towers, the user device can obtain location proof and anonymous credentials from nearby devices (NDs). At line 1 (314), the user device can broadcast a PoL request to NDs for the current time and location. At lines 2-3 (316), upon receiving responses, the user device can verify its credentials with the ND using the FCC's public key. If valid, at lines 4-6 (318), the ND can establish a secret session key ss via an interactive authenticated key agreement and perform a symmetric distance bounding protocol (DBP) to verify the client's proximity within a threshold th. At lines 7-10 (320), once confirmed, the ND can include the client's location (lₓ, l_{y}) and TS in its attributes and anonymously delegates a credential to the client with limited delegation capabilities. At lines 11-13 (322), using the FCC's public key and its own secret key, the user device can receive the delegated credential and location proof, certified within the extended attributes.

FIG. 3D implements the process 302d for querying spectrum availability (302d1), and reporting spectrum usage and accessing CRN services (302d2), with a focus on secondary users (SUs) as clients. The procedure for primary users PUs populating the database can mirror the process for querying PSDs.

Querying Spectrum Availability and CRN Services (302d1). Given the client's location coordinates (lₓ, l_{y}) and the current timestamp TS, the process can begin with obtaining a valid POL, either from an AP or nearby devices. In FIG. 3D, in areas with sufficient infrastructure, the client can (i) retrieve, at line 1 (324), the proof from an AP (e.g., using algorithm 302b), and then (ii) prove, at lines 2-4 (326), their credentials to a PSD while querying for spectrum availability or CRN services. In poorly infrastructured areas, at line 5 (328), the client can obtain proof of location and delegated credentials from an ND (e.g., using algorithm 302c). At lines 6-8 (330), the delegated credential, containing the proof of location as an extended attribute, can facilitate the client to anonymously prove their credentials to the PSD and submit queries for spectrum availability or CRN services. Clients can precompute multiple credentials offline for future use, enhancing efficiency and flexibility.

Upon receiving a query, at lines 9-10 (332), the PSD can validate the credentials and proof of location. For AP-based location proofs, the PSD can verify the group signature, while for ND-based proofs, the PSD can check the certified attributes, including the location proof, via the underlying signature verification. At lines 11-15 (334), based on the request for spectrum availability or CRN services, the PSD can generate a puzzle linked to the target server's public key and respond accordingly. While puzzle generation is included in the algorithm, PSDs can precompute puzzles with varying difficulty levels offline, similar to spectrum data. The difficulty can be determined based on the risk of DOS attacks and the server's resource capacity to manage responses. Using the device details embedded in credential attributes, the PSD can distribute the tailored puzzles accordingly. The online phase of the exemplary system only involves proving and verifying anonymous credentials during the query process, as location proof acquisition can be completed offline in advance.

Notifying Spectrum Usage and/or CRN Service Request (302d2). To report spectrum usage data or access CRN services, clients can solve the puzzle previously obtained, tied to the target server's public key. At lines 16-20 (336), given a message m, representing spectrum usage data or an access request, the client can compute the puzzle solution via repeated squaring and submit the puzzle solution, along with proof of their anonymous credentials, to the PSD or CRN server. Upon receiving the message and solution, the server can (i) validate, at line 21 (338), the anonymous credentials and (ii) verify, at line 22 (340), the puzzle solution. If both are verified, at line 23 (342), the PSD can update its database, or the CRN server can grant access to the requested resources. Spectrum usage notifications can also leverage anonymous credentials with attributes, improving frequency information quality while adhering to FCC coexistence requirements.

### Example Notations, Cryptographic Preliminaries, and Foundational Components in the Exemplary System

The exemplary system employs various security notations, cryptographic primitives, and elements, as described herein.

Notations. |x| and {0, 1} k signify the bit length of a variable and a k-bit binary value, respectively. ⊕ represents the XOR operation.

$${\{ {x}_{i} \}}_{i = 1}^{ℓ}$$

and ←S denote (x₁, x₂, . . . , xₗ) and random selection from the set S, respectively. Let G₁, G₂, and GT be prime-order groups with order p, and let e: G₁×G₂→G_{T} denote a bilinear map satisfying bilinearity and non-triviality. m[i] refers to the i-th element of the vector m, and h(·) denotes a cryptographically secure hash function. sk and pk are secret and public keys, respectively.

Delegatable Anonymous Credentials (DAC). An attribute-based DAC can be used for anonymous authentication, built upon structure-preserving signatures on equivalence classes of updatable commitments (SPSEQ-UC). Table 1 outlines the DAC-related algorithms and algorithm functions used in FIGS. 3B-3D.

TABLE 1

| Algorithm function | Description |
|---|---|
| (pp, sk_{RI}, pk_{RI}) ← Setup(1^{λ}, 1^{t}, 1^{η}) | Given the security parameter λ, an upper bound t for the set |
| | commitment scheme's maximum cardinality, and a length |
| | parameter η > 1, the function can produce the system's public |
| | parameters pp along with a signing key sk_{RI} and a public key pk_{RI} |
| | for each level i ∈ [η] associated with the root issuer (RI), where |
| | pp is implicitly provided as input to all subsequent algorithm |
| | functions. |
| (pk, sk) ← KeyGen(pp) | Given pp, the function can generate the user's key pairs (sk, |
| | pk), where pk is the initial pseudonym. |
| (nym, aux) ← NymGen(pk) | Given a user's public key pk, the function can generate a |
| | pseudonym nym and auxiliary information aux (randomness) |
| | for its usage. |
| CreateCred(L′, A, sk_{RI}) ↔ | An interactive function between RI and a user identified by |
| GetCred(pk_{RI}, skᵤ, A) → (cred, (\vec{C}, | nymᵤ. Given pp, the RI's public key pk_{RI}, and attribute set A, the |
| \vec{O}), dk_{L′}) | RI can generate a delegatable root credential for the user via the |
| | SPSEQ-UC signature. This credential is rooted at pk_{IR} and |
| | created for a set commitment C certifying the attribute set A. |
| | The user device can receive the credential cred, the opening |
| | information O, and a delegatable key dk_{L′} for level L′. |
| IssueCred(pk_{RI}, dk_{L′}, skᵤ, credᵤ, Aₗ, | This interactive function involves a delegator (nymᵢ) and a |
| L″) ↔ ReceiveCred(pk_{RI}, skᵣ, Aₗ) → | delegatee (nymᵣ). The delegator can use inputs including pp, |
| (credᵣ, dk′_{L″}) | pk_{RI}, attribute set Aₗ, delegation key dk_{L′}, secret key skᵢ, |
| | credential credᵢ, and auxiliary information auxᵢ to generate a |
| | new credential credᵣ. The delegatee, using their secret key skᵣ |
| | and pk_{RI}, can receive credᵣ with an extended attribute set A′ = |
| | (A, Aₗ) and a delegation level L″ satisfying L″ ≤ L′. The new |
| | credential can include an updated delegation key dk′_{L″}, allowing |
| | further delegation if permitted. |
| CredProve(pk_{RI}, skₚ, nymₚ, auxₚ, | This interactive function facilitates a credential holder to |
| credₚ, D) ↔ CredVerify(pk_{RI}, nymₚ, | anonymously prove ownership of their credential to a verifier. |
| D) → {0, 1} | The prover, identified by pseudonym nymₚ, uses their secret |
| | key skₚ, auxiliary information auxₚ, and credential credₚ to |
| | generate a proof validating credₚ with respect to a disclosed |
| | attribute set D. The verifier, using the RI's public key pk_{RI} and |
| | the prover's pseudonym nymₚ, verifies the proof against the |
| | disclosed attributes. If the proof is valid, the verifier outputs 1; |
| | otherwise, the verifier outputs 0. |

Distance Bounding Protocol (DBP). A DBP can verify the physical proximity of two network entities by measuring message transmission times during a rapid challenge-response exchange. A public key-based DBP [18], built on a one-pass authenticated key agreement (AKA) protocol using the nonce-Diffie-Hellman scheme, can be used to establish a session key between the prover (P) and verifier (V). This can be further combined with a symmetric DBP operating on the session key. Table 2 shows the DBP-related algorithm functions used in FIGS. 3B-3D.

TABLE 2

| Algorithm function | Description |
|---|---|
| ss ← AKA(sk, pk, pk′) | P and V derive the session key ss using their own key pair and the other's |
| | public key pk′. |
| {0, 1} ← SymDBP(ss, th) | This is an interactive algorithm function between P and V to verify |
| | proximity, given a distance threshold th and session key ss. |
| | (1) Initialization phase: V selects message m ∈ {0, 1}²ⁿ and sends m |
| | to P. P computes a = ss⊕m. |
| | (2) Rapid Bit Exchange phase (time-critical): V sends challenges (cᵢ |
| | ∈ {0, 1}) to P, who computes responses (rᵢ = a_{2i+c}_{ᵢ}₋₁_{) and returns} |
| | them. V measures round-trip times (timerᵢ) over n rounds. |
| | (3) Authentication phase: V verifies proximity using a = ss ⊕ m, the |
| | round-trip times, the allowed delay, and the speed of light. V checks |
| | timerᵢ ≤ 2 × th and rᵢ = a_{2i+c}_{ᵢ}₋₁_{.} |
| | If the prover P is within th, the algorithm outputs 1; otherwise, 0. |

Group Signature (GS). A GS facilitates a group member to anonymously sign a message on behalf of the group [20]. The exemplary system can adopt a variant of the BBS group signature scheme [17] characterized by short signatures, provable security, and high efficiency; its algorithm functions are used in FIGS. 3B-3D and outlined in Table 3.

TABLE 3

| Algorithm function | Description |
|---|---|
| pp_{G} ← BBS.Setup(1^{λ}) | Given the security parameter λ, this function runs a |
| | group parameter generation algorithm GGen(.) and |
| | outputs (p, G₁, G₂, G_{T}, e(.)). Then, the function obtains |
| | ${g}_{1} ← {G}_{1}^{*} , {g}_{2} ← {G}_{2}^{*} , and {h}_{1} ← {G}_{1}^{ℓ} , and returns the public$ |
| | parameters pp_{G} < (p, g₁, h₁, G₂, G₁, G₂, G_{T}, e(.)). |
| (sk, GK) ← BBS.KeyGen(pp_{G}) | $Given {pp}_{G} , this function computes x ← {Z}_{p} , {X}_{2} ← {g}_{2}^{x} ,$ |
| | and outputs (sk ← x, GK ← X₂). |
| σ ← BBS.Sign(sk = x, m) | Given the message m and the secret key sk, this |
| | function outputs the group signature σ = (A, ē) by |
| | $performing C ← {g}_{1} {Π}_{i} {{h}_{1} [ i ]}^{m [ i ]} , \overline{e} ← {D}_{\overline{e}} , and A ← {C}^{\frac{1}{x + \overline{e}}} .$ |
| {0, 1} ← BBS.Verify(GK, | On input the message m, signature σ, and the group |
| m, σ = (A, ē)) | public key GK, this function checks C ← gₗΠᵢhₗ[i]^{m[i]} |
| | $and returns 1 if e ( A , {g}_{2}^{\overline{e}} . v k ) = e ( C , {g}_{2} ) ; otherwise , the$ |
| | function returns 0. |

Time-Lock Puzzle (TLP). TLP [21] can encrypt messages that are decryptable only after a set time. The exemplary system can adopt the RSA-based TLP [22], leveraging non-parallelizable repeated squaring. Unlike hash-based puzzles, the TLP can prevent acceleration via multiple machines. Table 4 shows TLP-related algorithm functions used in FIGS. 3B-3D.

TABLE 4

| Algorithm function | Description |
|---|---|
| Π ← Puzzle.Gen(1^{λ}, κ) | Given the security parameter λ, this algorithm function follows the |
| | same procedure as the RSA key generation [21], resulting in a private |
| | key d and its modular inverse e = d⁻¹ (mod ϕ(n)). The difficulty κ can |
| | be set as the number of modular squarings required, determined by κ = |
| | T · S, where S is the squarings-per-second rate of a reference machine |
| | and T is the desired solving time. The value r = 2^{κ} (mod ϕ(n)) can be |
| | computed, followed by the public exponent ë = 2^{κ} + ϕ(n) − r + e, |
| | where z = ϕ(n) − r + e. The lower bits of ë can be composed of z, |
| | prefixed by a sequence of 0 bits and a leading 1 bit. Finally, the |
| | function outputs the pk ← Π = (n, ë) and the sk ← ψ = (n, d), with the |
| | public key efficiently represented as (n, κ, z). |
| ψ ← Puzzle.Sol(m, (n, ë) | Given Π = (n, ë) and the message 0 < m < n chosen by the puzzle |
| | solver, this function can produce c = c₁ · c₂ (mod n), where cᵢ = m²^{^{κ}} |
| | (mod n) and c₂ = m^{z} (mod n). Then, the function can set the solution |
| | as ψ = (m, c). |
| {0, 1} ← Sol.Verify(d, ψ) | Using the secret key d and solution ψ, this function can verify the |
| | correctness of c^{d} (mod n) = m and return 1 if valid; otherwise, the |
| | function can return 0. |

### Experimental Results and Additional Examples

A study was conducted to develop and evaluate an exemplary system (also referred to as “SLAP”) including at least a spectrum access system, a client/user device, an access point or a nearby device, and a public server, as described in relation to FIGS. 1-3.

### Security Analysis

Table 5 shows the security proofs addressing the exemplary system and method (a threat model).

TABLE 5

| Lemma/Corollary | Proof |
|---|---|
| Lemma 1: The exemplary system | The exemplary system can provide robust anonymity, |
| provides anonymous user authentication | preventing any entity from tracing or inferring user identity |
| by using the strong anonymity, | or information beyond the required credentials during both |
| soundness, and unforgeability properties | issuance/delegation and presentation phases. Malicious |
| of the ZKPoK and SPSEQ-UC signature | verifiers cannot differentiate between users, and this strong |
| schemes. | anonymity is achieved without relying on a trusted setup. |
| | The exemplary system's anonymity is grounded in the |
| | knowledge soundness of Zero-Knowledge Proof of |
| | Knowledge (ZKPoK), the Decisional Diffie-Hellman |
| | (DDH) assumption, and the SPSEQ-UC scheme [23], |
| | collectively ensuring origin-hiding, conversion privacy, and |
| | derivation privacy [14]. Origin-hiding can guarantee |
| | indistinguishability of randomized signatures; derivation |
| | privacy ensures extended commitment vectors remain |
| | indistinguishable; and conversion privacy ensures new |
| | signatures generated with switched user keys are |
| | indistinguishable from fresh signatures. These privacy |
| | properties can be repeatedly applied in any order without |
| | compromising security. |
| Corollary 1: The exemplary system can | The location privacy of SLAP can be ensured by the |
| provide location privacy for spectrum | unlinkability of signature-commitment pairs generated using |
| access via the unlinkability of the | the SPSEQ-UC scheme [14], which can be achieved through |
| credentials formed from the signature | signature re-randomization and user public key switching, |
| and commitment pairs. | enabling the repeated disclosure of the same commitment- |
| | signature pair without linkability. Provided no identifying |
| | attributes are included, newly generated signatures are |
| | indistinguishable from the originals. This property, proven |
| | secure under the group model, can ensure that credential |
| | presentations remain unlinkable to verifiers. |
| Lemma 2: The exemplary system can | In the AP scenario, the risk of fraud against the AP can |
| ensure location verification of the users | be negligible due to the robust security measures in place. |
| during spectrum access and queries via | Connection to the AP can be secured using a broadcasted |
| (i) the unforgetability of the group | sequence number transmitted within a short time window |
| signatures and enhanced signal strength | (e.g., 100-500 ms), mitigating potential attacks [24], while |
| measurements; (ii) public key distance- | proximity can be validated through signal strength |
| bounding protocol and anonymous | measurements. The AP's group signature on the cred, PoL, |
| delegation of credentials. | and TS can verify that the user is within the AP's coverage |
| | area. The unforgeability of the GS, grounded in the q-SDH |
| | assumption and supported by a tighter security proof in the |
| | algebraic group model, ensures the integrity of the location |
| | verification provided to the PSD [17]. Additionally, the |
| | location proof is non-transferable, as it is cryptographically |
| | bound to the current TS and the user's verified credentials. |
| | In the ND scenario, location verification can be ensured |
| | through the following mechanisms. (i) The security of the |
| | AKA protocol, based on the hardness of the Diffie-Hellman |
| | and discrete logarithm problems in the random oracle model |
| | [18]. (ii) The negligible failure probability of the symmetric |
| | DBP [19]. Specifically, in the canonical OTDB scheme [18], |
| | with m ∈ {0, 1}²ⁿ during initialization, the optimal |
| | probability for an adversary to correctly respond to all |
| | challenges is (¾)ⁿ, providing strong resistance to distance |
| | fraud, mafia fraud, and distance hijacking [18]. (iii) The |
| | unforgeability and anonymity of DAC delegation. An |
| | adversary attempting to forge a new delegated credential |
| | with another user's certified PoL should either forge the |
| | SPSEQ-UC scheme or compromise the NIZK proof scheme, |
| | both of which are secure [14]. |
| Corollary 2: The exemplary system can | The security of the TLP can be grounded in Rivest's |
| offer a counter-DoS mechanism for | construction [21], which can rely on the hardness of the |
| spectrum access, usage notification, and | integer factorization problem and the computational |
| obtaining CRN services via public-key | properties of modular exponentiation with a power-of-two |
| time-lock puzzles. | exponent. Specifically, deriving c without performing κ |
| | modular exponentiation operations during puzzle-solving |
| | (line 18 in algorithm 302d) can be computationally |
| | infeasible for an adversary. Furthermore, reducing ë to e and |
| | computing ø(n) is as hard as factoring n into its two large |
| | prime factors. To maintain security, the PSD should avoid |
| | disclosing multiple ë values associated with the same key |
| | pair, as such disclosure may enable efficient factorization of |
| | n and compromise the scheme. |

### Performance Evaluation

The study evaluated the exemplary system and described the evaluation metrics and experimental results (e.g., computational costs and cryptographic, communication, and storage overheads) herein.

Evaluation Metrics and Rationale. The study conducted analytical and empirical evaluations of the exemplary system, assessing its computational costs and communication overhead across all phases and employed security primitives, including delegatable anonymous credentials (DAC), group signature (GS), distance bounding protocol (DBP), and time-lock puzzle (TLP). As no existing solutions provide a similar set of features, a direct performance comparison is not feasible. Instead, the study provided a detailed performance analysis of the exemplary system across key metrics to evaluate its feasibility and practicality. Additionally, the study presented a qualitative and analytical comparison with selected schemes addressing subsets of these features in the context of spectrum query to spectrum access systems (SAS).

Hardware, Software Libraries, and Parameters. The study conducted the experiments on a desktop with an 11th Gen Intel Core i9-11900K@3.50 GHz, 64 GiB RAM, 1 TB SSD, running Ubuntu 22.04.4 LTS. The implementation utilized libraries and tools such as DAC-from-EQS, bbs-node reference, time-lock-puzzle, and OpenSSL. The study used these tools for implementing cryptographic primitives, including hash functions, modular arithmetic, exponentiation, and components of the exemplary system. The setup included SHA-256 for hashing, for set commitments, for SPSEQ-UC, BN256 curve for binding and ECC, Schnorr-style ZKP with Damgard's technique for DAC [14], and NIZKs derived via the FiatShamir heuristic, achieving approximately 100-bit security.

Table 6 summarizes the analytical and empirical evaluation of cryptographic overhead, computational costs, and communication overhead for each phase of the exemplary system. In Table 6, G₁, G₂, and G_{T} denote exponentiation in the respective groups. E^{k} represents a k-pairing product, where k=1 corresponds to a single pairing operation; P denotes pairing over the BN-256 curve. EM represents modular multiplication (n=2048). rnd denotes random string selection, H is a cryptographically secure hash function (SHA-256), and S_{q} represents the repeated squaring time to solve a puzzle. O(1) signifies signal transmission and internet communication time, typically in the microsecond range. Let D=(dᵢ)_{i∈[k]} and S=Uᵢdᵢ for all i ∈ [k], where k is the delegation level (L=2 in the exemplary system), and (dᵢ, uᵢ) denotes disclosed and undisclosed attributes at level i. K represents puzzle difficulty. Bits and bytes are denoted by b and B, respectively. Group sizes are |G₁|=|Zₚ|=256b, |G₂|=512b, and |G_{T}|=3072b, with modular arithmetic over n=2048. Messages |m|<256B, timestamps |TS| are 8B (on a 64-bit Unix system), high-precision location coordinates are 16B, and spectrum availability information |8| (based on FCC raw data) is approximately 560B.

TABLE 6

| | | | Empirical | Communication |
|---|---|---|---|---|
| Phase | Entity | Analytical Computation Cost | Cost | Overhead |
| PoL.AP (proof of location with AP) | Client | $( ( k + 11 ) {G}_{1} + 3 {G}_{2} + {G}_{1}^{2} ) + {G}_{1}^{\vert D \vert} +$ $1 P + 3 {G}_{T} + ( {\sum }_{i = 1}^{\vert D \vert} ( {G}_{1}^{{u}_{i}} + {G}_{1} ) )$ | 20.17 ms | ((k + 8)\|G₁\| + 2\|G₂\| + 3\|Zₚ\|)\|TS\| + \|(lₓ, l_{y})\| = 2008B |
| | AP | $2 {E}^{k} + {E}^{2} + 5 E + {G}_{2}^{\vert S \vert} + 3 {G}_{T} +$ $9 {G}_{1} + O ( 1 ) + {\sum }_{i = 1}^{\vert D \vert} ( {G}_{2}^{\vert S - {d}_{i} \vert} + {G}_{2} )$ | 61.26 ms | |
| PoL.ND (proof of location with ND) | Client | $( ( k + 3 ) {G}_{1} + {G}_{2} + {G}_{1}^{2} ) +$ ${E}_{M} + H + rnd + O ( 1 ) +$ $( {G}_{1}^{\vert D \vert} ) + ( {\sum }_{i = 1}^{\vert D \vert} ( {G}_{1}^{{u}_{i}} + {G}_{1} ) )$ | 31.75 ms | |
| | ND | $( 2 {E}^{k} + {E}^{2} + 5 E + {G}_{2}^{\vert S \vert} +$ $3 {G}_{1}^{2} + 2 {G}_{1}^{n} + {G}_{2}^{2} ) + ( k + 5 ) {G}_{1} +$ ${G}_{2} + {\sum }_{i = 1}^{\vert D \vert} ( {G}_{2}^{\vert S - {d}_{i} \vert} + {G}_{2} ) +$ ${E}_{M} + H + rnd + O ( 1 )$ | 78.05 ms | (3k + 8)\|G₁\| + 4\|G₂\| + (TS\| + \|(lₓ, l_{y})\| + (k + 1)\|Zₚ\| = 1856B |
| Spectrum query | Client | $( ( k + 3 ) {G}_{1} + {G}_{2} + {G}_{1}^{2} ) +$ $( {G}_{1}^{\vert D \vert} ) + ( {\sum }_{i = 1}^{\vert D \vert} ( {G}_{1}^{{u}_{i}} + {G}_{1} ) ) + O ( 1 )$ | 17.22 ms | (k + 5)\|G1\| + \|G2\| + \|Zₚ\| + \|TS\| + \|(lx, ly)\| +\|β\| = 3080B |
| | PSD | $2 {E}^{k} + {E}^{2} + 5 E + {G}_{2}^{\vert S \vert} +$ $1 P + 3 {G}_{T} + 2 {G}_{2} + 8 {G}_{1} +$ $O ( 1 ) + {\sum }_{i = 1}^{\vert D \vert} ( {G}_{2}^{\vert S - {d}_{i} \vert} + {G}_{2} )$ | 61.39 ms | |
| Notify/Service Request | Client | $κ \times {S}_{q} + {E}_{M} + ( k + 3 ) {G}_{1} + 2 {G}_{2} +$ ${G}_{1}^{2} + ( {G}_{1}^{\vert D \vert} ) + ( {\sum }_{i = 1}^{\vert D \vert} ( {G}_{1}^{{u}_{i}} + {G}_{1} ) )$ | 17.22 ms + κ × S_{q} | (k + 5)\|G1\| + \| G2\| + \|Zₚ\| \|m\| + \|TS\| + \|Π\| + \|ψ\| = 2304B |
| | PSD | $2 {E}^{k} + {E}^{2} + 5 E + {G}_{2}^{\vert S \vert} +$ ${G}_{2} + {\sum }_{i = 1}^{\vert D \vert} ( {G}_{2}^{\vert S - {d}_{i} \vert} + {G}_{2} )$ | 59.01 ms | |

Cryptographic Overhead. To prove a credential, the user device randomized their cred and nym and employed a ZKPoK on the secret key sk and randomness aux to generate a new randomized nym along with a subset of attributes D using a set commitment scheme. Signature conversion, signature representation adjustment, and adaptation for a new set commitment took approximately 2 ms, 5 ms, and 13 ms, respectively. On commodity hardware, solving puzzles at difficulty levels K (number of squarings) set to 103, 15×103, 50× 103, 105, and 106 required 3.9 ms, 56.31 ms, 194 ms, 784 ms, and 3.786 s, respectively. Verifying a puzzle solution, which involved RSA decryption (modular exponentiation), takes about 797 μs. Group signing and verification were completed in 2.26 ms and 3.17 ms, respectively, with batch verification reducing costs on the PSD side. In the employed DBP, the AKA required one ECC multiplication (0.612 ms), one hashing (0.35 ms), and random string selection (0.045 ms). Rapid bit exchange occured on a nanosecond scale, with a & distance fraud probability corresponding to changes around 100 cm, negligible compared to other protocol aspects. For algorithm function ProxVerify ( ) performed by the AP using signal strength and RTT techniques, the process took approximately 1-10 ms.

Computational Costs. (i) Proof of Location with AP (POL.AP) phase: the client proved anonymity and verified the group signature, while the AP validated credentials, executed the ProxVerify algorithm, and generated a group signature for the location proof.
(ii) Proof of Location with Nearby Devices (PoL.ND) phase: this phase involved interactive protocols between two user devices, including credential proof and verification, key agreement, symmetric DBP, and credential delegation/receipt with the location proof as a certified attribute.
(iii) Spectrum Query phase: the user device submitted a valid location proof (from the AP or ND) when querying a PSD for spectrum availability at specific coordinates and timestamps. The PSD verified credentials, checked the location proof, and provided spectrum information along with a public key puzzle tailored to the user's attributes.
(iv) Notifying Spectrum Usage or Requesting CRN Services phase: the user device solved the PSD or CRN server's public key puzzle, proved credentials, and submitted the solution. The PSD/server verified the solution before granting access to services or updating the database.

Communication Overhead. The communication complexity and data sizes for each phase are summarized in Table 6. In the exemplary system, all attributes can have uniform size. The credential included |cred|+|sk|+|nym| within the set commitment and SPSEQ-UC schemes, maintaining a constant size independent of the number of attributes, calculated as 4|G₁|+|G₂|+|Zₚ|, resulting in a credential size of 1792 b. The size of C corresponded to the delegation level (L=2), with communication complexity increasing linearly with the number of attributes and delegations. Using publicly available raw database data from the FCC, the study estimated that each database block contained approximately 560 bytes of information, supplemented with synthetic data for evaluation purposes.

Comparison with State-of-the-Art Systems. The study performed a qualitative and analytical comparison of the achieved features with other state-of-the-art location privacy systems/schemes, as detailed in Table 7. For a fair evaluation, the study considered spectrum query costs from both the client's and PSD's perspectives, system communication overhead, and end-to-end delay for retrieving a single block from the geo-location databases as a measure of scalability. As shown in Table 7, the exemplary system delivered all necessary features for secure, location-private, and anonymous spectrum access, while providing architecture-flexible and efficient location verification with the lowest end-to-end delay and minimal communication burden on the system.

TABLE 7

Features

| System/ | | Location | | Location | |
|---|---|---|---|---|---|
| Scheme | Setting | Privacy | Anonymous | Verification | Counter-DoS |
| Troja et al [25] | 1-DB | Peer-to-Peer | ✓ | X | X |
| Li et al [12] | 1-DB | Pseudo-ID | X | WiFi AP + | X |
| | | | | Location | |
| | | | | Server | |
| Xin et al [7] | 1-DB | PIR | X | WiFi AP + | X |
| | | | | QRA | |
| LP-Chor [16] | [symbol] -DB | PIR | X | X | X |
| LP-Goldberg | [symbol] -DB | PIR | X | X | X |
| [16] | | | | | |
| RAID-LP- | [symbol] -DB | PIR | X | X | X |
| Chor [16] | | | | | |
| Zeng et al [26] | 1-DB | BS + ECC | PseudoID | X | X |
| TrustSAS [5] | [symbol] -DB | PIR | EPID | X | X |
| PACDoSQ [6] | [symbol] -DB | PIR | Tor | X | HBP |
| SLAP | 1-DB | DAC | DAC | WiFi AP + GS | TLP |
| (this study) | | | | DBP + DAC | |

| | Delay | | | | | | | | | |
|---|---|---|---|---|---|---|---|---|---|---|
| | | | Private | | | | Proof of | | | |
| System/ | Secondary | | spectrum | | End-to-End | | Location | | Total | |
| Scheme | user (SU) | | data (PSD) | | (E2E) | | (PoL) | | Communication | |
| Troja et al | 1650 | ms | 11760 | ms | 13410 | ms | X | | 12 | MB |
| [25] | | | | | | | | | | |
| Li et al [12] | X | | X | | X | | 210 | ms | X | |
| Xin et al [7] | 292.8 | ms | 142.7 | ms | 407.4 | ms | 430.1 | ms | 325 | KB |
| LP-Chor [16] | 7.7 | ms | 480 | ms | 620 | ms | X | | 753 | KB |
| LP-Goldberg | 320 | ms | 1210 | ms | 1780 | ms | X | | 6 | MB |
| [16] | | | | | | | | | | |
| RAID-LP- | 0.4 | ms | 22 | ms | 210 | ms | X | | 125 | KB |
| Chor [16] | | | | | | | | | | |
| Zeng et al | 87 | ms | 27 | ms | 135 | ms | X | | 1.24 | KB |
| [26] | | | | | | | | | | |
| TrustSAS [5] | 329.4 | ms | 324.6 | ms | 4954 | ms | X | | 1.25 | MB |
| PACDoSQ [6] | 28.1 | ms | 199 | ms | 1373.6 | ms | X | | 605.92 | KB |
| SLAP | 17.22 | ms | 61.39 | ms | 78.61 | ms | 107.17 | ms | 3.08 | KB |
| (this study) | | | | | | | 109.8 | ms | | |

Note:
BS = base station, HBP = hash-based puzzles, GS = group signature, QRA = quadratic residue assumption, and EPID = enhanced privacy ID based on direct anonymous attestation.

### DISCUSSION

Spectrum Access Systems (SAS) have become the technology for dynamic spectrum allocation, enabling efficient sharing among primary (PU) and secondary users (SU) while ensuring regulatory compliance and interference management. An example is the Citizens Broadband Radio Service (CBRS) in the United States, which operates in the 3.5 GHz band for federal and satellite services [1]. However, SAS introduces privacy and security challenges due to its reliance on continuous reporting of user location and transmission details to geo-location databases, raising concerns about user anonymity and privacy [2]. The location-based nature of SAS also makes it vulnerable to spoofing, location fraud, and falsified data, increasing the risk of unauthorized spectrum access [3]. Furthermore, its database-driven architecture leaves SAS and Cognitive Radio Networks (CRNs) susceptible to denial-of-service (DOS) attacks, which compromise spectrum availability and system efficiency [4]. Despite various solutions targeting privacy protection, location verification, and DoS resistance, existing approaches remain isolated and fail to comprehensively address these issues.

Location Privacy and Anonymous Spectrum Access in Database-Driven CRN. Compliance with Federal Communications Commission (FCC) regulations in centralized SAS requires the disclosure of sensitive user information, including precise location coordinates, spectrum channel preferences, usage data, and transmission details, to query spectrum availability. This mandatory reporting raises serious privacy concerns, such as location privacy breaches, identity tracing, and the exposure of behavioral patterns. Existing location-privacy schemes often have limitations. Many focus solely on SUs, neglecting PUs, where their impact on spectrum information is critical. Computationally or information-theoretically secure Private Information Retrieval (PIR) methods require resource-intensive operations or involve extensive communication with multiple non-colluding databases, thereby imposing high computational and communication overhead [5-7]. Approaches based on k-anonymity and pseudo-identifiers fail to provide provable security, offering weak privacy guarantees unless an impractically large k value is used, which is infeasible for large-scale networks with numerous users [8], [9]. Similarly, differential privacy-based methods degrade the accuracy of spectrum availability information [10]. These shortcomings highlight the need for efficient mechanisms that ensure robust security, full anonymity, and strong location privacy against all network entities without compromising system performance and user experience.

Location Proof and Spoofing Attack Resistance in SAS. SAS, viewed as location-based services reliant on real-time user data, depend on the accuracy and integrity of this information for efficient and fair spectrum allocation. However, adversaries can exploit this reliance by impersonating legitimate entities or falsifying location and usage data, thereby manipulating spectrum allocation and causing spectrum interference, operational disruptions, and economic losses. Previous studies addressing location proofs in SAS fail to mitigate broader threats, including location spoofing, distance fraud, mafia attacks, and distance hijacking [3], [11]. Many solutions rely on impractical assumptions, such as the existence of dedicated location-proof servers [12], the inherent honesty of some entities [7], or the availability of trusted infrastructure like WiFi or cellular access points in all locations. These assumptions are unrealistic, especially in rural or sparsely populated areas where such infrastructure may be absent, limiting the applicability of these methods. Additionally, most schemes fail to safeguard location privacy and anonymity against access points or location servers, leaving a significant gap. Thus, there is a need for a practical and robust location verification mechanism in SAS that ensures privacy, anonymity, and resilience against diverse attack scenarios while aligning with the operational constraints of real-world deployments.

DOS countermeasures for SAS and CRN Services. The proliferation of inexpensive devices (e.g., IoT) and the reliance of SAS on geo-location databases have amplified the risk of DOS attacks [4]. These attacks overwhelm systems with malicious requests, disrupting spectrum allocation and degrading performance, particularly during spectrum usage notifications and CRN service requests. Previous solutions include intrusion detection systems (IDSs), blockchain, cryptographic techniques like client puzzles, and game-theory-based methods [13]. While AI-based detection excels at identifying attacks, it focuses on detection rather than prevention and requires extensive network-wide knowledge and access to sensitive user traffic, an impractical approach for real-time SAS countermeasures. Similarly, client-puzzle protocols face challenges such as distribution inefficiencies, parallelization vulnerabilities, and excessive overhead on both servers and users, which limits their feasibility. There is a need for efficient DoS countermeasures tailored to tasks such as spectrum usage notifications and CRN service requests, ensuring resilience without imposing undue resource burdens.

### CONCLUSION

As used in the specification and the appended claims, the singular forms “a,” “an” and “the” include plural referents unless the context clearly dictates otherwise. Ranges may be expressed herein as from “about” one particular value, and/or to “about” another particular value. When such a range is expressed, another implementation includes from the one particular value and/or to the other particular value. Similarly, when values are expressed as approximations, by use of the antecedent “about,” it will be understood that the particular value forms another implementation. It will be further understood that the endpoints of each of the ranges are significant both in relation to the other endpoint, and independently of the other endpoint.

“Optional” or “optionally” means that the subsequently described event or circumstance may or may not occur and that the description includes instances where said event or circumstance occurs and instances where it does not.

Throughout the description and claims of this specification, the word “comprise” and variations of the word, such as “comprising” and “comprises,” means “including but not limited to,” and is not intended to exclude, for example, other additives, components, integers or steps. “Exemplary” means “an example of” and is not intended to convey an indication of a preferred or ideal implementation. “Such as” is not used in a restrictive sense but for explanatory purposes.

Disclosed are components that can be used to perform the disclosed methods and systems. These and other components are disclosed herein, and it is understood that when combinations, subsets, interactions, groups, etc. of these components are disclosed while specific reference of each various individual and collective combinations and permutation of these may not be explicitly disclosed, each is specifically contemplated and described herein, for all methods and systems. This applies to all aspects of this application, including, but not limited to, steps in disclosed methods. Thus, if there are a variety of additional steps that can be performed it is understood that each of these additional steps can be performed with any specific implementation or combination of implementations of the disclosed methods.

The following patents, applications, and publications, as listed below and throughout this document, are hereby incorporated by reference in their entirety herein.
[1] P. Agarwal, M. Manekiya, and T. Ahmad, “A survey on citizens broadband radio service (cbrs),” Electronics, vol. 11, no. 23, 2022.
[2] S. Shi, Y. Xiao, W. Lou, C. Wang, X. Li, Y. T. Hou, and J. H. Reed, “Challenges and new directions in securing spectrum access systems,” IEEE Internet of Things Journal, vol. 8, no. 8, pp. 6498-6518, 2021.
[3] N. Nguyen-Thanh, D.-T. Ta, and V.-T. Nguyen, “Spoofing attack and surveillance game in geo-location database driven spectrum sharing,” IET Communications, vol. 13, no. 1, pp. 74-84, 2019.
[4] G. Jakimoski and K. Subbalakshmi, “Denial-of-service attacks on dynamic spectrum access networks,” in IEEE International Conference on Communications Workshops. IEEE, 2008, pp. 524-528.
[5] M. Grissa, A. A. Yavuz, B. Hamdaoui, and C. Tirupathi, “Anonymous dynamic spectrum access and sharing mechanisms for the cbrs band,” IEEE Access, vol. 9, pp. 33 860-33 879, 2021.
[6] S. Darzi and A. A. Yavuz, “Privacy-preserving and post-quantum counter denial of service framework for wireless networks,” in IEEE Military Communications Conference (MILCOM).

IEEE, 2024, pp. 1076-1081.
[7] J. Xin, M. Li, C. Luo, and P. Li, “Privacy-preserving spectrum query with location proofs in database-driven crns,” in 2016 IEEE Global Communications Conference (GLOBECOM). IEEE, 2016, pp. 1-6.
[8] L. Zhang, C. Fang, Y. Li, H. Zhu, and M. Dong, “Optimal strategies for defending location inference attack in database-driven crns,” in 2015 IEEE International Conference on Communications (ICC).
[9] R. Zhu, L. Xu, Y. Zeng, and X. Yi, “Lightweight privacy preservation for securing large-scale database-driven cognitive radio networks with location verification,” Security and Communication Networks, 2019.
[10] M. Ul Hassan, M. H. Rehmani, M. Rehan, and J. Chen, “Differential privacy in cognitive radio networks: a comprehensive survey,” Cognitive Computation, vol. 14, no. 2, pp. 475-510, 2022.
[11] K. Zeng, S. K. Ramesh, and Y. Yang, “Location spoofing attack and its countermeasures in database-driven cognitive radio networks,” in 2014 IEEE Conference on Communications and Network Security, 2014.
[12] Y. Li, L. Zhou, H. Zhu, and L. Sun, “Privacy-preserving location proof for securing large-scale database-driven cognitive radio networks,” IEEE Internet of Things Journal, vol. 3, no. 4, pp. 563-571, 2015.
[13] S. Darzi and A. A. Yavuz, “Counter denial of service for next-generation networks within the artificial intelligence and post-quantum era,” in IEEE 6th International Conference on Trust, Privacy and Security in Intelligent Systems, and Applications. IEEE, 2024, pp. 138-147.
[14] O. Mir, D. Slamanig, B. Bauer, and R. Mayrhofer, “Practical delegatable anonymous credentials from equivalence class signatures,” Proceedings on Privacy Enhancing Technologies, 2023.
[15] M. Grissa, A. Yavuz, and B. Hamdaoui, “Trustsas: A trustworthy spectrum access system for the 3.5 ghz cbrs band,” in IEEE INFOCOM Conf. on Computer Communications. IEEE, 2019, pp. 1495-1503.
[16] M. Grissa and A. A. Yavuz, “Location privacy in cognitive radios with multi-server private information retrieval,” IEEE Transactions on Cognitive Communications and Networking, 2019.
[17] S. Tessaro and C. Zhu, “Revisiting bbs signatures,” in Annual International Conference on the Theory and Applications of Cryptographic Techniques. Springer, 2023, pp. 691-721.
[18] H. Kilinc, and S. Vaudenay, “Efficient public-key distance bounding protocol,” in 22nd International Conference on the Theory and Application of Cryptology and Information Security. Springer, pp. 873-901.
[19] S. Vaudenay, “Private and secure public-key distance bounding: application to nfc payment,” in International Conference on Financial Cryptography and Data Security. Springer, 2015, pp. 207-216.
[20] A. A. Yavuz, K. Sedghighadikolaei, S. Darzi, and S. E. Nouma, “Beyond basic trust: Envisioning the future of nextgen networked systems and digital signatures,” in 5th IEEE Intern. Conf. on Trust, Privacy and Security in Intelligent Systems and Applications (TPS-ISA). IEEE, 2023.
[21] R. L. Rivest, A. Shamir, and D. A. Wagner, “Time-lock puzzles and timed-release crypto,” 1996.
[22] Y. I. Jerschow and M. Mauve, “Offline submission with rsa time-lock puzzles,” in 2010 10th IEEE International Conference on Computer and Information Technology. IEEE, 2010, pp. 1058-1064.
[23] G. Fuchsbauer, C. Hanser, and D. Slamanig, “Structure-preserving signatures on equivalence classes and constant-size anonymous credentials,” Journal of Cryptology, vol. 32, pp. 498-546, 2019.
[24] S. Saroiu and A. Wolman, “Enabling new mobile applications with location proofs,” in Proceedings of the 10th workshop on Mobile Computing Systems and Applications, 2009, pp. 1-6.
[25] E. Troja and S. Bakiras, “Leveraging p2p interactions for efficient location privacy in database-driven dynamic spectrum access,” in 22nd ACM SIGSPATIA Conference, 2014, pp. 453-456.
[26] Y. Zeng, L. Xu, X. Yang, and X. Yi, “An efficient privacy-preserving protocol for database-driven cognitive radio networks,” Ad hoc networks, vol. 90, p. 101739, 2019.

What is claimed:

1. A system having at least one private spectrum database (PSD), the system comprising:
a processor; and
a memory having instructions stored thereon, wherein execution of the instructions causes the processor to:
receive, from a user device, a privacy-preserving request for spectrum usage of or access to a public server, wherein the privacy-preserving request includes at least proof of location group signature of the user device, wherein the proof of location group signature was provided by an access point after validating location coordinates of the user device being in proximity to the access point, and wherein the privacy-preserving request includes location coordinates, time stamp (TS) of the privacy-preserving request, and one or more anonymous credentials, each of the user device;
determine, via a signature validation operation, the validity of the proof of location group signature of the one or more anonymous credentials of the user device;
generate a time-based puzzle using a public key and the timestamp of the privacy-preserving request; and
transmit the generated time-based puzzle to the user device, wherein the transmitted time-based puzzle is used by the user device in a computation task to determine a solution, and wherein the solution and the one or more credentials of the user device are transmitted to the public server in a request by the user device for spectrum usage of, or access to, the public server.

2. The system of claim 1, wherein the privacy-preserving request includes a set of delegated credentials of the user device, wherein the set of delegated credentials, formed in part by the location coordinates of the user device and the timestamp of the privacy-preserving request, were provided to the user device by a nearby device, the execution of the instructions causes the processor to:
prior to the generation of the time-based puzzle, determine, via a delegated credentials validation operation, validity of the set of delegated credentials using the public key and each of the set of delegated credentials.

3. The system of claim 1, wherein the puzzle is generated, via a puzzle generation operation, based on at least one predefined criteria, including security level and difficulty level.

4. The system of claim 1, wherein the privacy-preserving request is in form of a secured message.

5. The system of claim 1, wherein the public server is a cognitive radio network (CRN) server.

6. The system of claim 1, wherein the time-based puzzle is a time lock puzzle.

7. The system of claim 1, wherein the validity of the proof of location group signature is determined using a public key and each of the one or more anonymous credentials of the user device.

8. An access point (AP) comprising:
a processor; and
a memory having instructions stored thereon, wherein execution of the instructions causes the processor to:
receive, from a user device, a privacy-preserving request having location coordinates maintained at the user device, a timestamp for the request, and one or more anonymous credentials of the user device;
determine, via a proximity validation operation, validity of the location coordinates of the user device; and
generate and associate a group signature with at least one of the location coordinates, the timestamp, and the anonymous credentials of the user device; and
transmit the generated group signature to the user device in reply to the privacy-preserving request, wherein the user device uses the generated group signature as proof of location when sending a privacy-preserving PSD request for spectrum usage of, or access to, a public server from a user device.

9. The access point of claim 8, wherein the proximity validation operation comprises:
determining a received signal strength (RSS) of the transmission of the privacy-preserving request;
measuring a round-trip time (RTT) for the transmission of the privacy-preserving request; and
estimating a physical distance of the user device to the AP using the determined RSS and the measured RTT, wherein the location coordinates are valid when the location coordinates are within the estimated physical distance.

10. A non-transitory computer-readable medium having instructions stored thereon for a user device, wherein execution of the instructions by a processor of the user device causes the processor to:
in response to having a connection with an access point (AP):
retrieve location coordinates of the user device from memory;
retrieve one or more anonymous credentials from the memory;
transmit, to the AP, a privacy-preserving request having the location coordinates, a timestamp (TS) of the request, and the retrieved one or more anonymous credentials, each for the user device; and
receive, from the AP, a group signature associated with each of the location coordinates, the timestamp (TS), and the one or more anonymous credentials as proof of location, wherein the AP determines, via a proximity validation operation, validity of the location coordinates prior to the user device receiving the group signature; and
transmit, to a spectrum access system (SAS) having at least one private spectrum database (PSD), a second privacy-preserving request for spectrum usage of, or access to, a public server, wherein the second privacy-preserving request includes (i) the one or more anonymous credentials and (ii) the proof of location of the user device;

11. The non-transitory computer-readable medium of claim 10, wherein execution of the instructions by the processor of the user device further causes the processor to:
in response to having no connection to the AP:
broadcast a third privacy-preserving request to one or more nearby devices, the third privacy-preserving request having the location coordinates, a time stamp (TS) of the third request, and the one or more anonymous credentials, each of the user device, wherein the one or more nearby device is configured to determine validity of the one or more anonymous credentials using a public key; and
receive a set of delegated credentials from the nearby device as proof of location, wherein the set of delegated credentials is formed, in part, by the location coordinates of the user device and the timestamp of the third request;
transmit, to the SAS, a fourth privacy-preserving request for spectrum usage of, or access to, a public server, wherein the fourth privacy-preserving request includes (i) the set of delegated credentials and (ii) the proof of location of the user device.

12. The non-transitory computer-readable medium of claim 10, wherein execution of the instructions by the processor of the user device further causes the processor to:
receive a time-based puzzle from the SAS, wherein the time-based puzzle is generated by the SAS using a public key and the timestamp of the request;
determine, via a repeated squaring operation, a solution to the received time-based puzzle; and
transmit the determined solution and the one or more anonymous credentials to the public server, wherein the public server (i) determines, via a credential verification operation, validity of the one or more anonymous credentials and (ii) determines, via a puzzle solution verification operation, validity of the determined solution.

13. The non-transitory computer-readable medium of claim 9, wherein execution of the instructions by the processor of the user device further causes the processor to:
receive a time-based puzzle from the SAS, wherein the time-based puzzle is generated by the SAS using a public key and the timestamp of the third request;
determine, via a repeated squaring operation, a solution to the received time-based puzzle; and
transmit the determined solution and the set of delegated credentials to the public server, wherein the public server (i) determines, via a credential verification operation, validity of the set of delegated credentials and (ii) determines, via the puzzle solution verification operation, validity of the determined solution.

14. The non-transitory computer-readable medium of claim 13, wherein in response to the one or more anonymous credentials and the solution being determined valid, the public server grants access to the user device.

15. The non-transitory computer-readable medium of claim 14, wherein in response to the one or more anonymous credentials and the solution being determined valid, the SAS updates the PSD.

16. The non-transitory computer-readable medium of claim 10, wherein the proximity validation operation comprises:
determining a received signal strength (RSS) of the transmission of the privacy-preserving request;
measuring a round-trip time (RTT) for the transmission of the privacy-preserving request; and
estimating a physical distance of the user device to the AP using the determined RSS and the measured RTT, wherein the location coordinates are valid when the location coordinates are within the estimated physical distance.

17. The non-transitory computer-readable medium of claim 10, wherein the proximity validation operation is configured to:
estimate a physical distance between the user device and the AP using the location coordinates of the user device and location coordinates of the AP; and
in response to the estimated physical distance being smaller than or equal to a distance threshold value, output an indication that the location coordinates of the user device is valid.

18. The non-transitory computer-readable medium of claim 10, wherein the received group signature is generated, via a group signature generation operation, using a security parameter and a secret key of the user device.

19. The non-transitory computer-readable medium of claim 10, wherein the privacy-preserving request is configured as a secured message.

20. The non-transitory computer-readable medium of claim 10, wherein the public server is a cognitive radio network (CRN) server.
